(19) United States
(12) Patent Application Publication
(10) Pub. No.: US 2020/0413150 A1
(43) Pub. Date: Dec. 31, 2020

(54) DISPLAY APPARATUS AND THE CONTROLLING METHOD THEREOF

(71) Applicant: SAMSUNG ELECTRONICS CO., LTD., Suwon-si (KR)

(72) Inventor: Kunsok KANG, Suwon-si (KR)

(73) Assignee: SAMSUNG ELECTRONICS CO., LTD., Suwon-si (KR)

(21) Appl. No.: 16/904,865

(22) Filed: Jun. 18, 2020

Related U.S. Application Data
(60) Provisional application No. 62/866,701, filed on Jun. 26, 2019.

(30) Foreign Application Priority Data
Jan. 2, 2020 (KR) 10-2020-0000373

(51) Int. Cl. H04N 21/485; H04N 21/482; H04N 21/4363; H04N 21/462; H04N 21/443; H04N 21/431; G06F 16/953; G06F 9/54

(52) U.S. Cl. CPC H04N 21/4858; H04N 21/482; H04N 21/43635; G06F 9/541; H04N 21/443; H04N 21/4316; G06F 16/953; H04N 21/4621

(57) ABSTRACT

A display apparatus, including a communicator; a display; an interface configured to connect to a dongle storing a first application based on a first OS; and a processor configured to: based on receiving a user command to execute the first application while the dongle is connected to the interface, transmit, to the dongle, a signal requesting execution of the first application through the interface, based on transmission of the signal, receive, from the dongle through the interface, an image received by the dongle from a first server by executing the first application, and additional information related to the image, execute a second application based on a second OS and receive, from a second server through the communicator, an additional image based on the additional information, and display the image on a first area of the display and display the additional image in a second area of the display.

### CROSS-REFERENCE TO RELATED APPLICATION(S)

This application is based on and claims priority under 35 U.S.C. § 119 to Korean Patent Application Number 10-2020-0000373, filed on Jan. 2, 2020, in the Korean Intellectual Property Office, and U.S. Provisional Patent Application No. 62/866,701, filed on Jun. 26, 2019, the disclosures of which are incorporated by reference herein in their entirety.

### BACKGROUND

### 1. Field

The disclosure relates to a display apparatus and a controlling method thereof. More particularly, the disclosure relates to a display apparatus capable of executing various applications and a controlling method thereof.

### 2. Description of Related Art

Recently, with the development of electronic technology, various electronic apparatuses have been developed. In particular, an electronic apparatus such as a television (TV) capable of executing various applications has recently been developed. The electronic device stores an application based on an operating system (OS) of the electronic apparatus in a memory, executes an application selected according to a user command, and provides various services such as a web surfing service, an image reproduction service, a social network service, or the like.

A user has a desire to receive more diverse services. In one example, a user has a desire to enjoy, through an electronic apparatus, not only a service which an application based on the OS of the electronic apparatus may provide but also a service which an application based on an OS different from the OS of the electronic apparatus may provide.

However, electronic apparatuses developed so far have a problem in that the electronic apparatuses may not provide a service which an application based on OS other than an application of the OS may provide. This results in that a user's needs to enjoy various services through a variety of applications based on a variety of OS may not be satisfied.

### SUMMARY

Provided is a display apparatus capable of executing various applications, and of connecting to a dongle capable of executing various application.

Additional aspects will be set forth in part in the description which follows and, in part, will be apparent from the description, or may be learned by practice of the presented embodiments.

In accordance with an aspect of the disclosure, a display apparatus includes a communicator; a display; an interface configured to connect to a dongle storing a first application based on a first operating system (OS); and a processor configured to: based on receiving a user command to execute the first application while the dongle is connected to the interface, transmit, to the dongle, a signal requesting execution of the first application through the interface, based on transmission of the signal, receive, from the dongle through the interface, an image received by the dongle from a first server by executing the first application, and additional information related to the image, execute a second application based on a second OS and receive, from a second server through the communicator, an additional image based on the additional information, and display the image on a first area of the display and display the additional image in a second area of the display.

The processor may be further configured to, based on receiving the additional information, execute a third application based on the second OS, perform a web search based on the additional information through the third application, and receive, from the second server through the communicator, information about the additional image based on the web search.

The first OS may be different from the second OS.

The interface may include a high definition multimedia interface (HDMI), and the processor may be further configured to transmit the signal requesting the execution of the first application to the dongle through a consumer electronics control (CEC) link of the HDMI.

The processor may be further configured to receive information about the image from the dongle through wired communication with the interface, and receive the additional information related to the image from the dongle through wireless communication with the communicator.

The processor may be further configured to identify a resolution of the image based on information about the image, based on the resolution of the image matching a resolution of the display, display the image on an entire area of the display, and based on the resolution of the image not matching the resolution of the display, display the image on the first area of the display and display the additional image on the second area of the display.

The processor may be further configured to, based on receiving a user command to change a size of one of the first area or the second area, change the size of the one of the first area or the second area according to the user command, and based on the changed size of the one of the first area or the second area, change a content included in the additional image and display the changed content on the display.

In accordance with an aspect of the disclosure, a method for controlling a display apparatus includes, based on receiving a user command to execute a first application based on a first operating system (OS) while a dongle storing the first application is connected to the display apparatus, transmitting, to the dongle, a signal requesting execution of the first application; based on transmission of the signal, receiving, from the dongle, an image received by the dongle from a first server by executing the first application, and additional information related to the image; executing a second application based on a second OS and receiving, from a second server, an additional image based on the additional information; and displaying the image on a first area of a display included in the display apparatus and displaying the additional image in a second area of the display.

The method may further include, based on receiving the additional information, executing a third application based on the second OS; performing a web search based on the additional information through the third application; and receiving, from the second server, information about the additional image based on the web search.

The first OS may be different from the second OS.

The signal requesting the execution of the first application may be transmitted to the dongle through a consumer electronics control (CEC) link of a high definition multimedia interface (HDMI).

Information about the image may be received from the dongle through wired communication, and the additional information related to the image may be received from the dongle through wireless communication.

The method may further include identifying a resolution of the image based on information about the image; based on the resolution of the image matching a resolution of the display, displaying the image on an entire area of the display; and based on the resolution of the image not matching the resolution of the display, displaying the image on the first area of the display and displaying the additional image on the second area of the display.

The method may further include, based on receiving a user command to change a size of one of the first area or the second area, changing the size of the one of the first area or the second area according to the user command; and based on the changed size of the one of the first area or the second area, changing a content included in the additional image and displaying the changed content on the display.

In accordance with an aspect of the disclosure, a method for controlling a display apparatus includes, based on detecting that a dongle storing a first application based on a first operating system (OS) is connected to the display apparatus, receiving from the dongle an icon image representing the first application; displaying the icon image on a display included in the display apparatus; based on receiving a user input selecting the icon image, transmitting to the dongle an execution signal requesting execution of the first application; based on the execution signal, receiving a first content image from the dongle and information about the first content image; based on the information about the first content image, executing by the display apparatus a second application based on a second OS to obtain a second content image related to the first content image; and displaying the first content image in a first area of the display and the second content image in a second area of the display.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a diagram illustrating a display system according to an embodiment;

FIG. 1B is a diagram illustrating a display system according to an embodiment;

FIG. 1C is a diagram illustrating a display system according to an embodiment;

FIG. 2 is a block diagram illustrating a dongle according to an embodiment;

FIG. 3 is a block diagram illustrating a display apparatus according to an embodiment;

FIG. 4 is a diagram illustrating a screen provided by a display apparatus to which a dongle is connected according to an embodiment;

FIG. 5 is a diagram illustrating an embodiment of displaying an image and an additional image according to an embodiment;

FIG. 6 is a diagram illustrating an operation of a display apparatus when a size of an area where an additional image is displayed according to an embodiment;

FIG. 7 is a diagram illustrating a multi-view image according to an embodiment;

FIG. 8 is a diagram illustrating an image including a code according to an embodiment;

FIG. 9 is a diagram illustrating an embodiment in which a screen split ratio is changed according to a posture of a user terminal according to an embodiment;

FIG. 10 is a detailed block diagram illustrating a display apparatus 200 according to an embodiment; and

FIG. 11 is a flowchart illustrating an operation of a display apparatus according to an embodiment.

### DETAILED DESCRIPTION

Hereinafter, embodiments of the disclosure will be described with reference to the accompanying drawings. However, it may be understood that the disclosure is not limited to the embodiments described hereinafter, but also includes various modifications, equivalents, and/or alternatives of these embodiments. In relation to explanation of the drawings, similar drawing reference numerals may be used for similar constituent elements.

In this specification, expressions such as “have,” “may have,” “include,” “may include” or the like represent presence of a corresponding feature (for example, components such as numbers, functions, operations, or parts) and does not exclude the presence of additional feature.

In this document, expressions such as “at least one of A [and/or] B,” or “one or more of A [and/or] B,” include all possible combinations of the listed items. For example, “at least one of A and B,” or “at least one of A or B” includes any of (1) at least one A, (2) at least one B, or (3) at least one A and at least one B.

As used herein, the terms “first,” “second,” or the like may denote various components, regardless of order and/or importance, and may be used to distinguish one component from another, and does not otherwise limit the components.

If a certain element (e.g., first element) is described as “operatively or communicatively coupled with/to” or “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a central processing unit (CPU) or an application processor) that can perform the corresponding operations by executing one or more software programs stored in a memory device.

A term such as “module,” “unit,” “part,” and so on is used to refer to an element that performs at least one function or operation, and such element may be implemented as hardware or software, or a combination of hardware and software. Further, other than when each of a plurality of “modules,” “units,” “parts,” and the like must be realized in an individual hardware, the components may be integrated in at least one module or chip and be realized in at least one processor.

Hereinafter, with reference to the attached drawings, embodiments will be described in detail.

The disclosure provides a display apparatus capable of providing various applications based on various operating systems and a method for controlling thereof.

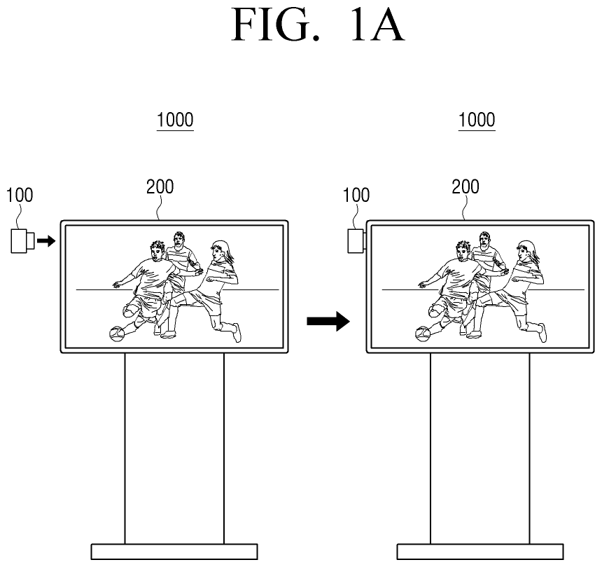

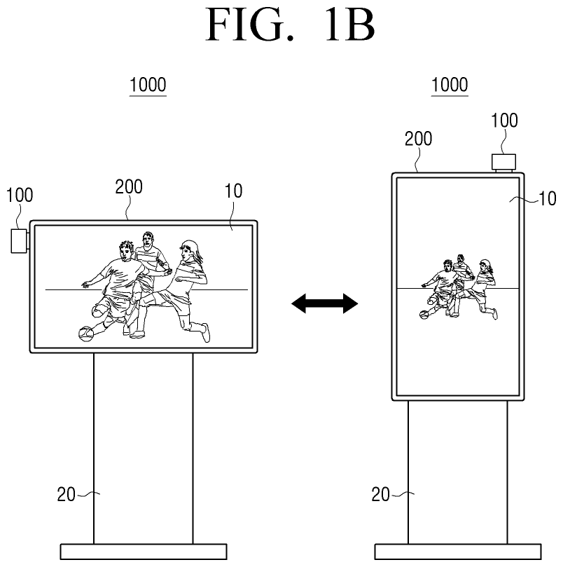

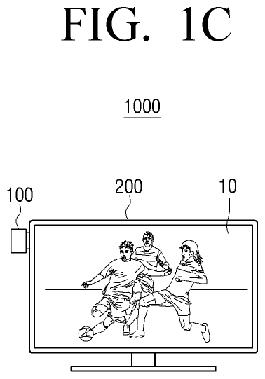

FIG. 1A is a diagram illustrating a display system according to an embodiment.

Referring to FIGS. 1A and 1B, a display system 1000 according to an embodiment may include a dongle 100 and a display apparatus 200.

As illustrated in FIG. 1A, the dongle 100 may be connected to the display apparatus 200. For example, a high definition multimedia interface (HDMI) connector 11 provided in the dongle 100 may be connected to the HDMI port provided in the display apparatus 200.

Accordingly, the display apparatus 200 and the dongle 100 may perform communication through the HDMI communication method.

The display apparatus 200 may be connected to a user terminal device such as a smart phone. For example, the display apparatus 200 may be connected to a user terminal device through a cradle or an adapter. Here, the cradle may be attached to one side of the display apparatus 200, and may be disposed in a separate area from the display apparatus 200. A universal serial bus (USB) port of a user terminal device may be connected to a USB connector of the cradle, or the USB port of the user terminal device may be connected to the USB port of the cradle through the cable. The HDMI connector of the cradle may be connected to the HDMI port of the display apparatus 200, or the HDMI port of the cradle may be connected to the HDMI port of the display apparatus 200 through the cable. Accordingly, the display apparatus 200 and the user terminal apparatus may perform communication through an HDMI communication method. For convenience, an operation of the dongle 100 will be mainly described, but the operation of the dongle 100 may be performed by a user terminal device connected to the display apparatus 200 through the cradle. For example, as described below, the display apparatus 200 may receive an execution screen of an application stored in the dongle 100 from the dongle 100. However, embodiments are not limited thereto and the display apparatus 200 may receive an execution screen of an application stored in the user terminal device from the user terminal device.

The display apparatus 200 may be implemented as a television (TV). As an example, as illustrated in FIG. 1B, the display apparatus 200 may be a TV that includes a rotatable display 10. The display 10 may be connected to a stand 20, rotated from a longitudinal direction to a horizontal direction, or rotated from a horizontal direction to a longitudinal direction. The display apparatus 200 may include a motor for rotating the display 10.

The display apparatus 200 may display various images through the display 10 disposed in a landscape (or horizontal) direction or a portrait (or vertical) direction.

The embodiment is merely an example, and the display apparatus 200 may be implemented as a TV, or the like, in which a display is not rotated as illustrated in FIG. 1C.

The display apparatus 200 may display a user interface screen on the display 10 using an operating system (OS) stored or installed in the display apparatus 200. Here, the OS may be an OS used in a TV, such as Tizen.

For example, the display apparatus 200 may display a home screen provided by the OS of the display apparatus 200 on the display 10. The home screen may include a graphical user interface (GUI) for selecting an input source of the display apparatus 200 or a graphical user interface (GUI) for displaying an application stored or installed in the display apparatus 200.

The display apparatus 200 may perform various operations based on a user command input through a home screen.

For example, if a user command for selecting a GUI indicating an input source connected to a set-top box is inputted, the display apparatus 200 may display an image received from the set-top box on the display 10, and output audio received from the set-top box through a speaker of the display apparatus 200.

As another example, if a user command for selecting a GUI indicating an application for providing a video service is inputted, the display apparatus 200 may access a server for providing a service through the application by executing the selected application, and display an image received from a server on the display 10.

The display apparatus 200 may receive an image from various external sources and display the received image on the display 10.

The display apparatus 200 may receive an image from the dongle 100 connected to the display apparatus 200 and display the received image on the display 10.

The dongle 100 may execute an application stored in the dongle 100 using the OS stored in the dongle 100 and transmit the image provided by the application to the display apparatus 200.

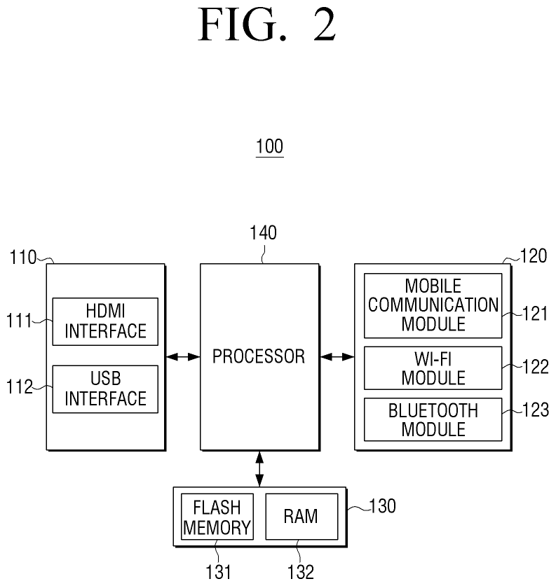

Referring to FIG. 2, the dongle 100 according to an embodiment will be described.

FIG. 2 is a block diagram illustrating a dongle according to an embodiment.

Referring to FIG. 2, the dongle 100 according to an embodiment may include an interface 110, a communicator 120, a memory 130, and a processor 140.

The interface 110 may be connected to the display apparatus 200. For example, the interface 110 may be connected to the display apparatus 200 using various communication methods such as HDMI, USB, or the like.

The interface 110 may include an HDMI interface 111 including a HDMI connector or a HDMI port for HDMI communication and a USB interface 112 including a USB connector or a USB port for USB 2.0 and/or USB 3.0 communication. The interface 110 may be directly connected to the display apparatus 200 or may be connected to the display apparatus 200 using a separate cable.

The communicator 120 may communicate with an external device. The communicator 120 may communicate with an external device using various communication methods such as mobile communication, Wi-Fi, Bluetooth, or the like.

The communicator 120 may include a mobile communication module 121 for mobile communication such as 3^{rd} generation (3G), 3^{rd} generation partnership project (3GPP), long term evolution (LTE), 5^{th} generation (5G), or the like, a Wi-Fi module 122 for Wi-Fi communication, and a Bluetooth module 123 for Bluetooth communication.

The mobile communication module 121 may access the Internet via mobile communication network to communicate with a server, and the Wi-Fi module 122 may be connected to the access point and access the Internet through the access point to communicate with a server. The Bluetooth module 123 may communicate with various devices located in the vicinity of the dongle 100.

The memory 130 may store various instructions and software programs, or the like, related to an operation of the dongle 100. The memory 130 may include a flash memory 131 and random access memory (RAM) 132.

The processor 140 may control overall operations of the dongle 100. The processor 140 may be electrically connected to the communicator 120 and the memory 130 for controlling the components.

The processor 140 may include a central processing unit (CPU) or an application processor (AP) and may execute at least one software program stored in the memory 130 according to one or more instruction stored in the memory 130.

For example, the processor 140 may drive the OS stored in a flash memory 131 using the RAM 132 when power is applied to the dongle 100. The OS may be an OS used in a portable device such as a smartphone, a tablet, etc., such as an Android OS. In embodiments, the OS of the dongle 100 may be different from the OS of the display apparatus 200.

The power applied to the dongle 100 may be provided from the display apparatus 200 connected to the dongle 100 via the USB interface 112. However, according to an embodiment, the dongle 100 may include a separate battery.

The processor 140 may load and execute the application stored in the flash memory 131 to the RAM 132 through the OS.

The application may be an application program running based on the OS of the dongle 100. For example, if the OS installed in the dongle 100 is an Android OS, the application may be an application program that may be executed on the Android OS. In this case, the application may be stored in the memory 130 in the manufacturing stage of the dongle 100, or downloaded from a server (e.g., a play store, etc.) that provides the application in accordance with the user command and stored in the memory 130.

The command to execute an application stored in the dongle 100 may be received from the display apparatus 200.

The processor 140 may transmit information about an application stored in the memory 130 to the connected display apparatus 200 through the interface 110. The information about the application may include information for identifying an application such as a name of an application, or the like.

The display apparatus 200 may use information about the application received from the dongle 100 to indicate to the display 10 a GUI representing the application stored in the dongle 100. For example, the display apparatus 200 may display on the display 10 a home screen that includes a GUI representing the application stored in the dongle 100.

The display apparatus 200, when the GUI is selected, may transmit a command requesting execution of an application corresponding to the selected GUI to the dongle 100.

When a command requesting execution of an application is received through the interface 110, the processor 140 may execute the corresponding application according to the received request. The processor 140 may access a server for providing a service through an application using the mobile communication module 121 or the Wi-Fi module 122, and may receive an image from a server through the mobile communication module 121 or the Wi-Fi module 122.

The processor 140 may transmit the received image to the display apparatus 200 via the interface 110. The display apparatus 200 may display an image received from the dongle 100 to the display 10.

A user command for the executed application may be input via a device connected to the dongle 100. Here, the device may be an input device such as a remote controller, a keyboard, a mouse, a game controller, or the like.

The processor 140 may search for a peripheral device of the dongle 100, perform pairing with the found device, and control the Bluetooth module 123 to perform communication connection with the device.

When the device is connected through the Bluetooth module 123, the processor 140 may receive the user command input to the device from the device through the Bluetooth module 123, transmit the received user command to a server for providing a service through the application via the mobile communication module 121 or the Wi-Fi module 122, receive the image in which the user command is processed from the server, and transmit the received image to the display apparatus 200 through the interface 110. The display apparatus 200 may display an image received from the dongle 100 to the display 10.

The user may connect an input device such as a remote controller, a keyboard, a mouse, a game controller, or the like, to the dongle 100 to control an application executed by the dongle 100.

As described above, according to an embodiment, in addition to the application stored in the display apparatus 200, the display apparatus 200 may display an execution screen of an application executed in the dongle 100 operating based on an OS different from the display apparatus 200 on the display 10. Accordingly, the user can receive various OS-based application execution screens through the display apparatus 200.

Because the dongle 100 may be based on an OS used in a portable device, such as a smartphone and a tablet, which are commonly used by a user, a user may control a TV through familiar user manipulation.

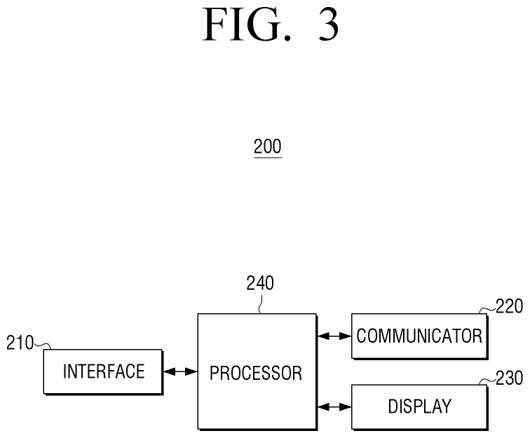

FIG. 3 is a block diagram illustrating a display apparatus according to an embodiment.

Referring to FIG. 3, the display apparatus 200 according to an embodiment may include an interface 210, a communicator 220, a display 230, and a processor 240.

The interface 210 may be connected to the dongle 100 and may transmit and receive various data with the dongle 100.

For example, the interface 210 may transmit, to the dongle, a signal requesting transmission of information for the application stored in the dongle 100, and receive information about the application stored in the dongle 100 from the dongle 100. Here, the information for the application may include information for identifying an application, such as a name of the application, or the like. In addition, the application stored in the dongle 100 may be an application based on an OS different from the application stored in the display apparatus 200.

The interface 210 may transmit, to the dongle, a signal requesting execution of the application stored in the dongle 100. In this case, the dongle 100 may execute the application based on the received signal. The dongle 100 may connect to a server for providing a service through an application using a mobile communication module or a Wi-Fi module, and receive an image from a server through a mobile communication module or a Wi-Fi module. The dongle 100 may transmit the received image to the display apparatus 200 through an interface.

The interface 210 may receive an image provided by an application from the dongle 100.

When a user command for controlling an image displayed on the display apparatus 200 is input to the display apparatus 200, the interface 210 may transmit a signal for controlling the image to the dongle 100 according to a user command. The user command may be input through a button provided in the display apparatus 200 or a touch screen of the display apparatus 200, and may be input through a remote control device communicating with the display apparatus 200.

The interface 210 may receive an image controlled according to a user command from the dongle 100.

The interface 210 may also receive additional information from the dongle 100 associated with the image that the application provides. The additional information may be included in the image data received from the dongle 100, or may be included in meta-data received separately from the image data received from the dongle 100. Specifically, when a signal requesting the execution of an application is received from the display apparatus 200, the dongle 100 may request transmission of an image from a server providing an image through the application, and receive an image and additional information associated with the image from the server. The dongle 100 may transmit the image received from the server and the additional information related to the image to the display apparatus 200 through the interface 210 of the display apparatus 200.

The interface 210 may be implemented with a high definition multimedia interface (HDMI), and the interface 210 may include an HDMI connector or an HDMI port. This is merely exemplary, and the interface 210 may be implemented with various interfaces, such as a universal serial bus (USB).

The communicator 220 may communicate with various external devices and transceive various data.

For example, the communicator 220 may communicate with a server to transmit and receive various data. Here, the server may be a server that provides services based on the OS stored in the display apparatus 200.

Specifically, the communicator 220 may communicate with the server through various wireless communication methods such as 3G, 3GPP, LTE, 5G, or the like, to transmit and receive various data. For example, the communicator 220 may transmit a signal requesting execution of the application stored in the display apparatus 200 to the server, and receive information about the image provided by the application from the server. The communicator 220 may transmit a signal for controlling the image to the server according to the user command input to the display apparatus 200, and receive information about the controlled image from the server according to the user command.

The communicator 220 may also communicate with the server via an external electronic device. As an example, the communicator 220 may communicate with a server through various external electronic devices that relay communication between the display apparatus 200 and the server, such as an access point (AP), a router, or Internet of Things (IoT) hub. The communicator 220 may communicate with the server through a Wi-Fi network.

The communicator 220 may communicate with the dongle 100 to transceiver various data.

For example, the communicator 220 may transmit a signal requesting the execution of the application to the dongle 100, and receive, from the dongle 100, information about an image provided by the application that the dongle 100 receives from the server. When a user command for controlling an image provided by the application is inputted to the display apparatus 200, the communicator 220 may transmit a signal for controlling an image provided by the application to the dongle 100, and receive, from the dongle 100, information about the updated image according to the user command received by the dongle 100 from the server.

The communicator 220 may receive additional information related to the image provided by the application from the dongle 100. The additional information may be included in information about an image received from the dongle 100, or may be included in metadata separate from the image received from the dongle 100. When a signal requesting the execution of an application is received from the display apparatus 200, the dongle 100 may request transmission of an image from a server providing a service through the application, and receive an image and additional information related to the image from the server. The dongle 100 may transmit additional information related to the image and the image received from the server to the display apparatus 200 through the communicator 220 of the display apparatus 200. As an example, if the image provided by the application is a soccer image of a team A, the additional information may include site information for broadcasting the game of the team A, information about the soccer match schedule of the team A, or profile information of the soccer player belonging to the team A, or the like.

The communicator 220 may transmit a signal requesting an additional image based on the additional information to a server, and receive an additional image from the server. Here, the server may be a server providing a service through an application based on the OS of the display apparatus 200.

The communicator 220 may be communicatively connected to the dongle 100 through various wireless communication methods, such as a 3G, 3GPP, LTE, 5G, or the like, and may be communicatively coupled to the dongle 100 via a Wi-Fi network, a Bluetooth network, or the like. The communicator 220 may communicate with the dongle 100 via various external electronic devices that relay communications between the display apparatus 200 and the dongle 100, such as an AP, a router, IoT hub, or the like.

The display 230 may display a variety of images. Here, the display 230 may perform the same or similar functions as the display 10 described above. The image displayed on the display 230 may include at least one of a still image or a moving image, and the display 230 may display various images such as broadcast content, multi-media content, game content, or the like. The display 230 may also display various user interfaces (UIs) and icons.

For example, the display 230 may display an image provided by an application based on the OS of the display apparatus 200. The display 230 may display an image provided by an application based on the OS of the dongle 100, received from the dongle 100. The display 230 may display an additional image related to an image provided by an application based on the OS of the dongle 100, based on the additional information received from the dongle 100. The display 230 may display a mirroring image received from a user terminal device, such as a smart phone. The display 230 may display at least two images of the above-described images on one screen. For example, the display 230 may display an image provided by an OS of the display apparatus 200 and an image provided by an application based on the OS of the dongle 100 together.

The display 230 may be implemented as various types of displays such as a liquid crystal display (LCD) panel, light emitting diode (LED), organic light emitting diode (OLED), liquid crystal on silicon (LCoS), digital light processing (DLP), or the like. In the display 230, a backlight unit, a driving circuit which may be implemented as a format such as an a-Si TFT, low temperature poly silicon (LTPS) TFT, organic TFT (OTFT), or the like, may be included as well.

The processor 240 may control overall operations of the display apparatus 200. For this purpose, the processor 240 may include one or more of a central processing unit (CPU), an application processor (AP), a communication processor (CP), etc.

The processor 240 may drive an operating system or application program to control hardware or software components connected to the processor 240, and may perform various data processing and operations. The processor 240 may also load and process commands or data received from at least one of the other components into volatile memory and store the various data in non-volatile memory.

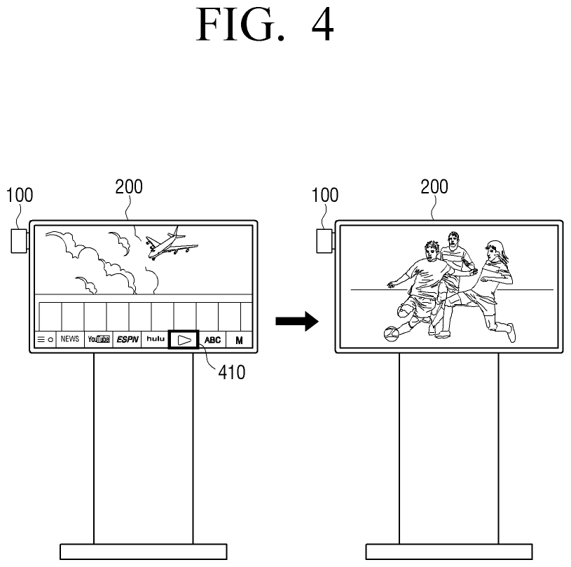

Hereinafter, embodiments will be described with reference to FIGS. 4 to 9.

The processor 240 may communicate with the dongle 100 to transmit and receive various data. Specifically, the processor 240 may be connected to the dongle 100 via the interface 210, and may transmit and receive various data to and from the dongle 100 via the interface 210. In embodiments, the processor 240 may be connected to the dongle 100 through the communicator 220 and transmit and receive various data to and from the dongle 100 through the communicator 220.

The processor 240 may receive, from the dongle 100, information about the application stored in the dongle 100 via the interface 210. Here, the application stored in the dongle 100 may be an application based on an OS different from the application stored in the display apparatus 200. That is, the application stored in the dongle 100 may be an application based on a first OS, and the application stored in the display apparatus 200 may be an application based on a second OS.

For example, if the processor 240 receives a user command to identify the application stored in the dongle 100, for example based on a source switch command, the processor 240 may transmit, to the dongle 100, a signal requesting transmission of information about the application stored in the dongle 100 via the interface 210.

The processor 240 may receive information about the application stored in the dongle 100 from the dongle 100 and display information about the application stored in the dongle 100 on the display 230. As an example, if the application stored in the dongle 100 is an application for video reproduction, the processor 240 may receive information from the dongle 100 about an application for video reproduction and display an icon 410 representing the application on the display 230, as illustrated in FIG. 4. This is merely exemplary, and the processor 240 may display a GUI, such as a thumbnail, text, or the like, indicating the application received from the dongle 100 to the display 230.

If a user command for executing an application stored in the dongle 100 is received, the processor 240 may transmit a signal requesting execution of the application to the dongle 100. In one example, the processor 240 may transmit, to the dongle 100, a signal requesting execution of the application via a consumer electronics control (CEC) link of the HDMI. Embodiments are not limited thereto and the processor 240 may transmit a signal requesting the execution of the application to the dongle 100 through the communicator 220.

For example, when a user command for executing an application for playing an image is received by the processor 240, the processor 240 may transmit a signal requesting execution of an application for image reproduction to the dongle 100. The user command may be received through a button provided in the display apparatus 200 or a touch screen of the display apparatus 200, and may be received through a remote controller communicating with the display apparatus 200.

The dongle 100 may execute the application stored in the dongle 100 based on the signal received from the display apparatus 200. When a signal requesting the execution of an application is received from the display apparatus 200, the dongle 100 may execute an application stored in the memory of the dongle 100, and transmit a signal requesting information about an image provided by the application to a server providing a service through the corresponding application.

The dongle 100 may transmit the information about the image received from the server to the display apparatus 200. The information about the image may be information associated with an initial screen provided by the corresponding application.

The display 230 may display an image provided by the application selected according to a user command through the display 230.

The processor 240 may display the various images provided by the application via the display 230 in accordance with the user's subsequent commands. When a user command for controlling an image provided by an application is received, the processor 240 may receive the updated image from the dongle 100 according to the user command.

The user command may be input through a button provided in the display apparatus 200 or a touch screen of the display apparatus 200, and may be input through a remote controller communicating with the display apparatus 200. In embodiments, the user command may be input to the dongle 100 via a remote controller communicating with the dongle 100.

When the user command to control an image is input to the display apparatus 200, the processor 240 may transmit, to the dongle 100, a signal for controlling an image according to the user command.

For example, if an application is an application for searching a web, and an image provided by an application is a page for a web search, based on a user command to search for a keyword being input, the processor 240 may transmit a signal requesting a keyword search and information about the inputted keyword to the dongle 100. As another example, if the application is an application for reproducing a moving image, and the image provided by the application is an image including a plurality of contents, the processor 240 may transmit, to the dongle 100, a signal requesting the reproduction of selected content based on a user command for the reproduction of any one of the plurality of contents included in the image.

In this case, when a signal for controlling an image is received from the display apparatus 200, the dongle 100 may transmit a signal requesting control of an image to a server providing an image through the application. The dongle 100 may receive from a server information about an updated image based on a user command. According to an embodiment, when an image provided by an application is an image including a plurality of contents, and a user command is a user command for reproduction of any one of the plurality of contents, the dongle 100 may receive information about the selected content according to a user command from a server.

The dongle 100 may transmit the information about the image received from the server to the display apparatus 200.

If the user command for controlling the image is input to the dongle 100, the dongle 100 may transmit, to the server, a signal requesting control of the image based on the user command. The dongle 100 may receive from the server information about an updated image based on the user command. The dongle 100 may transmit information about the image received from the server to the display apparatus 200.

The processor 240 may display the updated image via the display according to the user command. For example, if the user command is a command for reproducing a sports content, as illustrated in FIG. 4, the processor 240 may display the selected sports content via the display 230 in accordance with the user command.

As described above, in the display apparatus 200 according to an embodiment, by communicating with a dongle storing an application based on a first OS, the display apparatus 200 may reproduce an image provided by an application based on a second OS, which may be an OS of the display apparatus 200, and also an image provided by an application based on the first OS, which may be an OS of the dongle 100. Accordingly, a user may receive various services through various applications based on various OS.

If the processor 240 transmits, to the dongle 100, a signal requesting execution of the application stored in the dongle 100, the processor 240 may receive, from the dongle 100, additional information related to the image received from the server by executing the application by the dongle 100. The processor 240 may receive, from the dongle 100, information about an image through the interface 210 connected to the dongle 100 via a wired communication method, and may receive, from the dongle 100, additional information through the communicator 220 connected to the dongle 100 via a wireless communication method. However, in embodiments, the processor 240 may receive information about the image and additional information through the interface 210, and may receive information about the image and additional information through the communicator 220.

Based on a signal requesting execution of an application from the dongle 100, the server communicating with the dongle 100 may transmit, to the dongle 100, an image provided by the application and additional information related to the image.

The dongle 100 may transmit the image received from the server and the additional information related to the image to the display apparatus 200, and the processor 240 may receive additional information related to the image and the image from the dongle 100 through the interface 210. Here, the additional information may be included in the information about the image received from the dongle 100, and may be included in the received metadata separately from the information about the image. As an example, if the application is an application for reproducing an image, and an image provided by the application is a soccer image of the team A, the additional information may include site information for broadcasting the game of the team A, information about the soccer match schedule of the team A, or profile information of the soccer player belonging to the team A, or the like.

The processor 240 may execute an application based on the OS of the display apparatus 200 based on the additional information. Here, the application may be, for example, an application for web search. The processor 240 may transmit a signal requesting transmission of an additional image based on additional information to a server for providing an image through the application via the communicator 220.

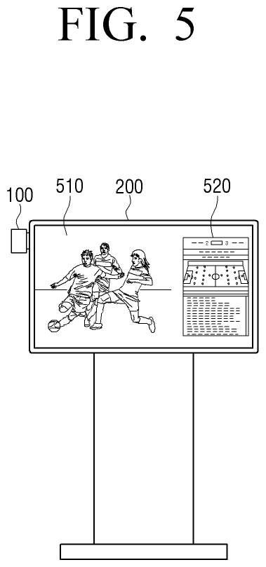

The processor 240 may display the additional image received from the server on the display 230. The processor 240 may display an image received from the dongle 100 in a first area of the display 230, and display an additional image received from the server in a second area of the display 230. For example, if the image received from the dongle 100 is a soccer game image of the team A and the additional image is an text broadcast screen provided by a site broadcasting the game of the team A, as illustrated in FIG. 5, the processor 240 may display the soccer game image 510 of the team A in the first area of the display 230 and display the text broadcast screen 520 in the second area of the display 230, as illustrated in FIG. 5.

The processor 240 may determine whether an additional image is displayed based on a mode of the display apparatus 200. The mode of the display apparatus 200 may be determined according to a user command received through a button provided in the display apparatus 200 or a touch screen of the display apparatus 200, and may be determined according to a user command input to a remote controller communicating with the display apparatus 200.

When the display apparatus 200 operates in a first mode, the processor 240 may display the image received from the dongle 100 in the entire area of the display 230, and may not display the additional image on the display 230.

When the display apparatus 200 operates in a second mode, the processor 240 may determine whether to display the additional image based on the resolution information of the image received from the dongle 100. Specifically, when an image provided by the application stored in the dongle 100 is received from the dongle 100, the processor 240 may determine the resolution of the image based on the resolution information of the image included in the information about the image. The processor 240 may determine whether to display an additional image based on the resolution of the display 230 and the resolution of the image. If the resolution of the image matches with the resolution of the display 230, the processor 240 may display an image received from the dongle 100 in the entire area of the display 230, and if the resolution of the image does not match the resolution of the display 230, the processor 240 may display the image received from the dongle 100 in the first area of the display 230, and display the additional image received from the server in the second area of the display 230. For example, if the resolution of the display 230 is 3840×2160, and the resolution of the image received from the dongle 100 is 1,920×1,080, the processor 240 may display the image received from the dongle 100 in the first area of the display 230, and display the additional image received from the server in the second area of the display 230.

When the display apparatus 200 operates in a third mode, the processor 240 may display the image received from the dongle 100 in the first area of the display 230, regardless of the resolution of the image, and may display the additional image received from the server in the second area of the display 230.

When a user command for changing the size of the first area or the second area is received, the processor 240 may change the size of the first area or the second area according to the user command. The user command may be input through a button provided in the display apparatus 200 or a touch screen of the display apparatus 200, and may be input through a remote controller communicating with the display apparatus 200. In embodiments, the user command may be input to the dongle 100 via a remote controller communicating with the dongle 100.

The processor 240 may change the content included in the additional image and display the changed content on the display 230 based on the changed size of the first area or the changed sized of the second area.

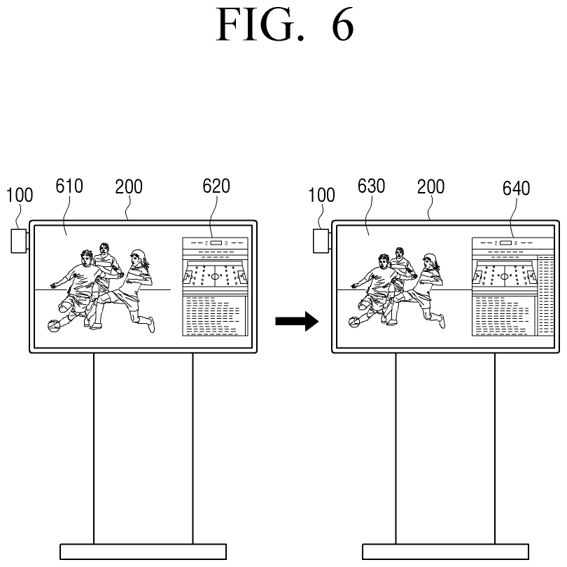

As an example, referring to FIG. 6, the processor 240 may change the size of the first and second areas according to a user command when a user command is received to reduce the landscape size of the first area displaying an image 610 received from the dongle 100, or a user command is recieved to enlarge the landscape size of the second area displaying an image 620 received from the server. The processor 240 may scale the image received from the dongle 100 to correspond to the size of the first area based on the changed size of the first area, and display the scaled image 630 in the first area. The processor 240 may render the additional image received from the server and display the rendered additional image 640 in the second area of the display 230 based on the changed size of the second area. For example, as illustrated in FIG. 6, when the landscape size of the second area is enlarged, the processor 240 may render the additional image 640 based on the modified size of the second area, to display the rendered additional image 640 in the second area of the display 230 further including content that is not included in the second area before the size change.

An embodiment of displaying an image received from the dongle 100 and the additional information received from the server on the display 230 is described above, but embodiments are not limited thereto. For example, according to embodiments, three or more images may be displayed on a display.

When a user command for executing an application stored in the display apparatus 200 is received, while the image received from the dongle 100 and the additional image received from the server are displayed on the display 230, the processor 240 may display a new image in a third area of the display 230. The third area may be generated according to a user command. When a user command for generating the third area is received by the processor 240, the processor 240 may adjust the size of the first area or the second area to generate a third area. Here, the user command may be a user command to adjust the size of the first area or the second area, or a separate user command to generate the third area. Such a user command may be input through a button provided in the display apparatus 200 or a touch screen of the display apparatus 200, and may be input through a remote controller communicating with the display apparatus 200. In embodiments, the user command may be input to the dongle 100 via a remote controller communicating with the dongle 100.

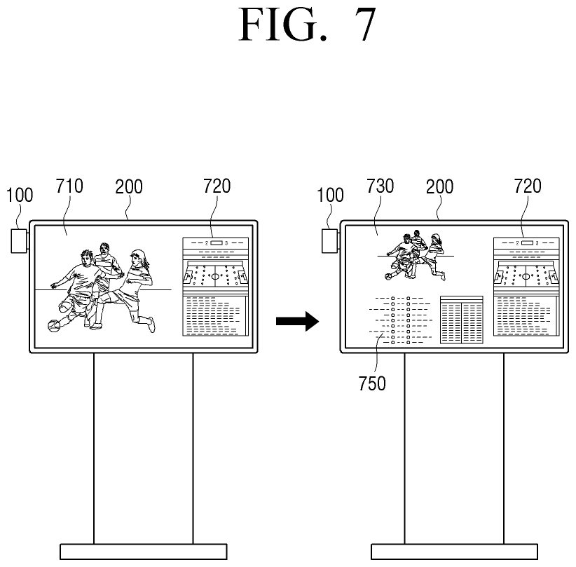

The processor 240 may display an image received from the server in the third area based on a user command for executing the application stored in the display apparatus 200. For example, referring to FIG. 7, when a user command for reducing the portrait size of the first area is received while the image 710 received from the dongle 100 is displayed in the first area and the image 720 received from the server in the second area is being displayed, the processor 240 may reduce the portrait size of the first area based on the user command. The processor 240 may scale the image received from the dongle 100 to correspond to the size of the first area based on the changed size of the first area, and display the scaled image 730 in the first area. The processor 240 may display the image 750 received from the server in the third area generated by the size reduction of the first area. The image displayed in the third area may be an image provided by an application based on the OS of the display apparatus 200, and may be any of a variety of images, such as an image including information about a soccer game score in another stadium, or an image provided by a chat application.

The user may be provided with various application execution screens based on various OS through a multi-view screen.

Additional information associated with the image may be coded and included in the image. For example, the dongle 100 may receive an image and additional information related to the image from a server, merge the image received from the server with a code linked to a site address providing an additional image based on the additional information, and transmit the code to the display apparatus 200.

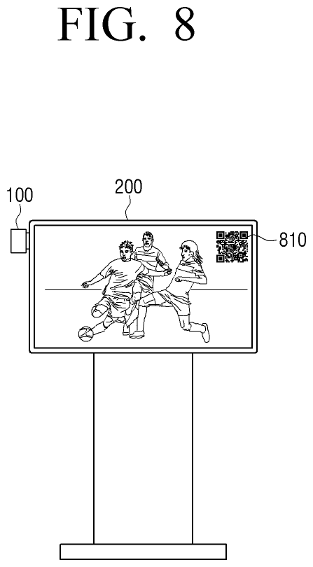

Referring to FIG. 8, the processor 240 may apply an object recognition algorithm to the image displayed on the display 230 to identify a code 810 included in the image. The processor 240 may determine a site address for providing the additional image based on the additional information included in the code, execute the application stored in the display apparatus 200, access a server of the site providing the additional image, and receive the additional image based on the additional information from the server.

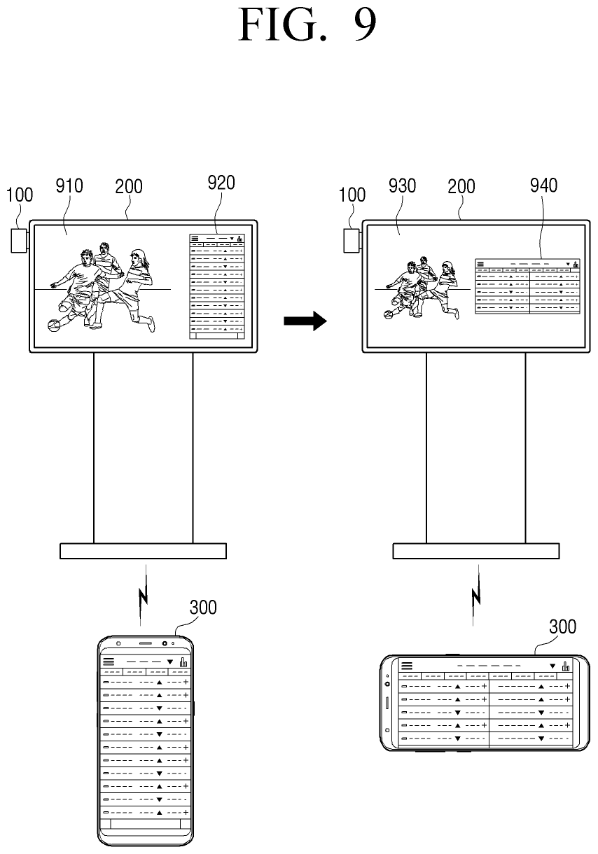

Referring to FIG. 9, the processor 240 may receive an image for mirroring from the user terminal device 300 through the communicator 220, display an image 910 received from the dongle 100 in the first area, and display a mirroring image received from the user terminal device 300 in the second area. For example, in a state where the processor 240 displays an image received from the dongle 100 over the entire area of the display, when a user command for screen segmentation is received, a user command for displaying an image received from the dongle 100 is received in the first area of the screen, and a user command for displaying the mirroring image is received in the second area of the screen, the processor 240 may display the image 910 received from the dongle 100 in the first area, and display the mirroring image received from the user terminal device 300 in the second area.

The processor 240 may change the size of the first and second areas based on information about a posture of a user terminal device 300. When the processor 240 receives information about the posture of the user terminal device 300 from the user terminal device 300 and determines that the user terminal device 300 has changed from a first posture to a second position based on the information about the posture of the user terminal device 300, the processor 240 may change the size of the first and second areas based on the second posture. The information about the posture of the user terminal device 300 may be received from the user terminal device 300 when the posture of the user terminal device 300 is changed. The display apparatus 200 and the user terminal device 300 may be connected to each other through various communication methods such as mobile communication, Wi-Fi, Bluetooth, or the like.

For example, referring to FIG. 9, when a user command for displaying an image received from the dongle 100 is received in the first area of the display 230, and a user command for displaying the mirroring image is received in the second area of the display 230, the processor 240 may display the image 910 received from the dongle 100 in the first area, and display the mirroring image 920 received from the user terminal device 300 in the second area. If it is determined that the user terminal device 300 has changed from a first posture (e.g., a portrait posture) to a second posture (e.g. a landscape posture) based on information about the posture of the user terminal device 300, the size of the first and second areas may be changed based on the second posture, the image 930 received from the dongle 100 may be displayed in the first area of the changed size, and the mirroring image 940 may be displayed in the second area of the changed size.

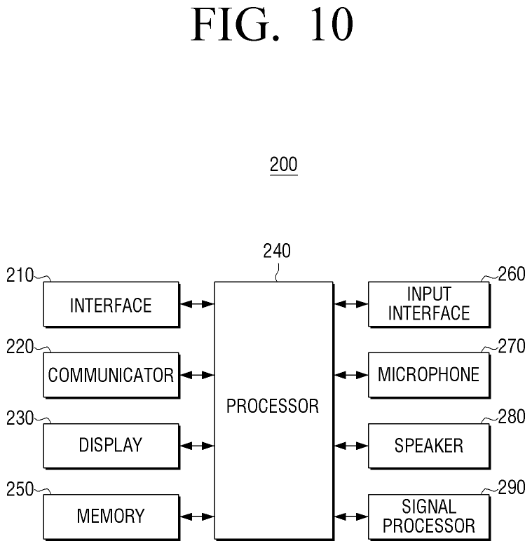

FIG. 10 is a detailed block diagram illustrating a display apparatus 200 according to an embodiment.

Referring to FIG. 10, the display apparatus 200 according to an embodiment may include an interface 210, a communicator 220, a display 230, a memory 250, an input interface 260, a microphone 270, a speaker 280, a signal processor 290, and a processor 240. In embodiments, many elements of display apparatus 200 as illustrated in FIG. 10 may be the same or similar to elements described above. Accordingly, to avoid repetition some description of these elements will be omitted or abbreviated.

The communicator 220 may communicate with an external device to transmit and receive various data. For example, the communicator 220 may communicate with the server through a local area network (LAN), an Internet network, a mobile communication network, and may communicate with the dongle 100 through various communication methods such as a mobile communication network, a Bluetooth (BT), a Bluetooth low energy (BLE), a wireless fidelity (Wi-Fi), a Zigbee, a near field communication (NFC), or the like.

The communicator 220 may include various communication modules to perform network communication. For example, the communicator 220 may include a Bluetooth module, a Wi-Fi module, a wireless communication module, or the like.

The communicator 220 may communicate with an external device to receive broadcast content (or a broadcast signal). Here, the broadcast content may include at least one of an image, audio, or additional data (e.g., electronic program guide (EPG)). The communicator 220 may include a tuner, a demodulator, an equalizer, or the like.

The memory 250 may store an instruction or data related to a component of the display apparatus 200 and an operating system (OS) for controlling overall operations of a component of the display apparatus 200.

The processor 240 may control multiple hardware or software components of the display apparatus 200 using various instructions or data stored in memory 250, load instructions or data received from at least one of the other components into a volatile memory, and store the various data in a non-volatile memory.

The memory 250 may store the OS of the display apparatus 200 and various applications based on the OS of the display apparatus 200.

The memory 250 may store information regarding an artificial intelligence (AI) model or an image recognition algorithm capable of identifying an object included in an image.

The input interface 260 may receive various user commands. The input interface 260 may perform a function corresponding to a user command input through the input interface 260.

For example, the input interface 260 may receive a user command for displaying information about the application stored in the dongle 100 on the display 230. The input interface 260 may receive a user command for executing an application stored in the dongle 100. The input interface 260 may receive a user command for executing an application stored in the memory 250.

The input interface 260 may also receive a user command for rotation of the display 230. The input interface 260 may receive a user command to perform turn-on, channel change, volume adjustment, etc., and the processor 240 may turn on the display 230 according to the input user command, change a channel, adjust a volume, or the like.

The input interface 260 may be implemented as an input panel. An input panel may be implemented as a keypad or touch screen including a touch pad or various function keys, numeric keys, special keys, character keys, or the like.

The microphone 270 may receive a user voice. The user voice may inlcude a voice command to execute a particular function of the display apparatus 200. When the user's voice is received through the microphone 270, the processor 240 may analyze the user's voice through a speech-to-text (STT) algorithm, and perform a function corresponding to the user's voice.

For example, based on receiving a user's voice command for executing an application stored in the dongle 100 through the microphone 270, the processor 240 may transmit a signal requesting execution of the application to the dongle 100.

The speaker 280 may output various audio. For example, the speaker 280 may output audio when receiving an image from the dongle 100.

The signal processor 290 may perform signal processing on the contents received through the communicator 220. Specifically, the signal processor 290 may perform operations such as decoding, scaling, and frame rate conversion on an image included in the content, and then may signal-process the image in a form that may be output from the display apparatus 200. The signal processor 290 may perform signal processing such as decoding on the audio constituting the content, and may process the audio in a form that may be output from the speaker 280.

The display 230 may display an image, or the like, output from the signal processor 290, and the speaker 280 may output audio output from the signal processor 290.

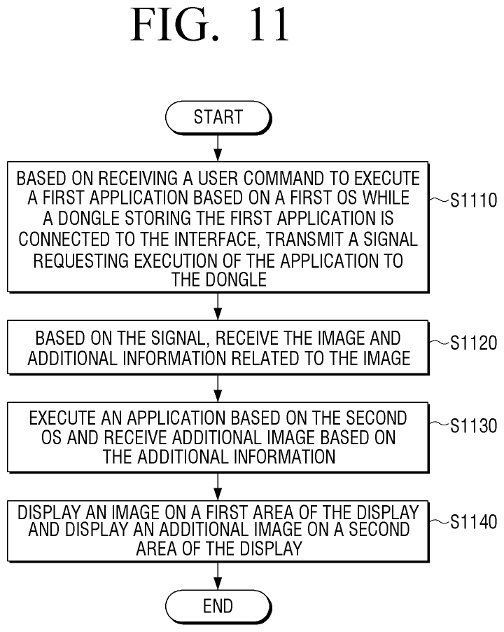

FIG. 11 is a flowchart illustrating an operation of a display apparatus according to an embodiment.

In the state where the dongle 100 storing an application based on a first OS is connected, when a user command for executing the application stored in the dongle 100 is received, the display apparatus 200 may transmit a signal requesting execution of the application to the dongle 100 in operation S1110. The first OS may be an OS used in a portable device like as a smartphone, a tablet, etc., such as an Android OS.

Specifically, when a user command for identifying an application stored in the dongle 100 is received through a source conversion command, the display apparatus 200 may transmit a signal requesting the transmission of information for the application stored in the dongle 100 to the dongle 100.

The display apparatus 200 may receive information about the application stored in the dongle 100 from the dongle 100 and display information about the application stored in the dongle 100 on the display. As an example, if the application stored in the dongle 100 is an application for image reproduction, the processor 240 may receive from the dongle 100 information about an application for image reproduction, and display an icon representing the application on the display 230.

When a user command for executing an application stored in the dongle 100 is received, the display apparatus 200 may transmit a signal requesting execution of the application to the dongle 100.

The display apparatus 200 may receive an image and additional information related to the image in operation S1120.

The display apparatus 200 may transmit a signal requesting the execution of the application stored in the dongle 100 to the dongle 100, and may receive, from the dongle 100, additional information associated with the image and the image received from the first server by executing the application. Here, the additional information may be included in the information about the image received from the dongle 100, and may be included in the meta data that is separate from the information about the image.

The display apparatus 200 may execute an application based on the second OS and receive an additional image based on the additional information in operation 51130.

When additional information is received by the display apparatus 200, the display apparatus 200 may execute an application based on the second OS, which is the OS of the display apparatus 200, on the basis of the additional information. Here, the application may be, for example, an application for web search. The display apparatus 200 may transmit a signal requesting transmission of an additional image based on additional information to a second server that provides an image through the application.

The display apparatus 200 may display an image on a first area of the display and display an additional image on a second area of a display in operation S1140.

The display apparatus 200 may display an image received from the dongle 100 in a first area of the display, and display an additional image received from the server in a second area of the display. As an example, if the image received from the dongle 100 is a soccer game image of the team A, and the additional image is an image provided by a site broadcasting the game of the team A, the display apparatus 200 may display the soccer game image of the team A in the first area of the display and display the text broadcast screen in the second area of the display.

According to various embodiments as described above, a display apparatus may provide a service provided by an application based on an OS of a display apparatus and an application based on another OS. By providing a plurality of services provided by a plurality of applications based on different OS together on one screen, a user may to receive various services at the same time.

The methods according to various embodiments may be implemented as a format of software or application installable to a related art display apparatus.

The methods according to various embodiments may be implemented by software upgrade of a related art display apparatus, or hardware upgrade only.

The various embodiments described above may be implemented through an embedded server provided in the electronic apparatus or a server outside the display apparatus.

A non-transitory computer readable medium which stores a program for sequentially executing a method for controlling a display apparatus according to an embodiment may be provided.

The non-transitory computer readable medium refers to a medium that stores data semi-permanently rather than storing data for a very short time, such as a register, a cache, a memory or etc., and is readable by an apparatus. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

While one or more embodiments have been described above with reference to the figures, it will be understood by those of ordinary skill in the art that various changes in form and details may be made therein without departing from the spirit and scope as defined by the following claims and their equivalents.

What is claimed is:

1. A display apparatus comprising:
a communicator;
a display;
an interface configured to connect to a dongle storing a first application based on a first operating system (OS); and
a processor configured to:
based on receiving a user command to execute the first application while the dongle is connected to the interface, transmit, to the dongle, a signal requesting execution of the first application through the interface,
based on transmission of the signal, receive, from the dongle through the interface, an image received by the dongle from a first server by executing the first application, and additional information related to the image,
execute a second application based on a second OS and receive, from a second server through the communicator, an additional image based on the additional information, and
display the image on a first area of the display and display the additional image in a second area of the display.

2. The display apparatus of claim 1, wherein the processor is further configured to:
based on receiving the additional information, execute a third application based on the second OS,
perform a web search based on the additional information through the third application, and
receive, from the second server through the communicator, information about the additional image based on the web search.

3. The display apparatus of claim 1, wherein the first OS is different from the second OS.

4. The display apparatus of claim 1, wherein the interface comprises a high definition multimedia interface (HDMI), and
wherein the processor is further configured to transmit the signal requesting the execution of the first application to the dongle through a consumer electronics control (CEC) link of the HDMI.

5. The display apparatus of claim 1, wherein the processor is further configured to:
receive information about the image from the dongle through wired communication with the interface, and
receive the additional information related to the image from the dongle through wireless communication with the communicator.

6. The display apparatus of claim 1, wherein the processor is further configured to:
identify a resolution of the image based on information about the image,
based on the resolution of the image matching a resolution of the display, display the image on an entire area of the display, and
based on the resolution of the image not matching the resolution of the display, display the image on the first area of the display and display the additional image on the second area of the display.

7. The display apparatus of claim 1, wherein the processor is further configured to;
based on receiving a user command to change a size of one of the first area or the second area, change the size of the one of the first area or the second area according to the user command, and
based on the changed size of the one of the first area or the second area, change a content included in the additional image and display the changed content on the display.

8. A method for controlling a display apparatus, the method comprising:
based on receiving a user command to execute a first application based on a first operating system (OS) while a dongle storing the first application is connected to the display apparatus, transmitting, to the dongle, a signal requesting execution of the first application;
based on transmission of the signal, receiving, from the dongle, an image received by the dongle from a first server by executing the first application, and additional information related to the image;
executing a second application based on a second OS and receiving, from a second server, an additional image based on the additional information; and
displaying the image on a first area of a display included in the display apparatus and displaying the additional image in a second area of the display.

9. The method of claim 8, further comprising:
based on receiving the additional information, executing a third application based on the second OS;
performing a web search based on the additional information through the third application; and
receiving, from the second server, information about the additional image based on the web search.

10. The method of claim 8, wherein the first OS is different from the second OS.

11. The method of claim 8, wherein the signal requesting the execution of the first application is transmitted to the dongle through a consumer electronics control (CEC) link of a high definition multimedia interface (HDMI).

12. The method of claim 8, wherein information about the image is received from the dongle through wired communication, and the additional information related to the image is received from the dongle through wireless communication.

13. The method of claim 8, further comprising:
identifying a resolution of the image based on information about the image;
based on the resolution of the image matching a resolution of the display, displaying the image on an entire area of the display; and
based on the resolution of the image not matching the resolution of the display, displaying the image on the first area of the display and displaying the additional image on the second area of the display.

14. The method of claim 8, further comprising:
based on receiving a user command to change a size of one of the first area or the second area, changing the size of the one of the first area or the second area according to the user command; and
based on the changed size of the one of the first area or the second area, changing a content included in the additional image and displaying the changed content on the display.

15. A method for controlling a display apparatus, the method comprising:
based on detecting that a dongle storing a first application based on a first operating system (OS) is connected to the display apparatus, receiving from the dongle an icon image representing the first application;
displaying the icon image on a display included in the display apparatus;
based on receiving a user input selecting the icon image, transmitting to the dongle an execution signal requesting execution of the first application;
based on the execution signal, receiving a first content image from the dongle and information about the first content image;
based on the information about the first content image, executing by the display apparatus a second application based on a second OS to obtain a second content image related to the first content image; and
displaying the first content image in a first area of the display and the second content image in a second area of the display.
